(19) United States
(12) Patent Application Publication
(10) Pub. No.: US 2026/0303485 A1
(43) Pub. Date: Oct. 1, 2026

(54) DYNAMIC INFORMATION TECHNOLOGY (IT) SUPPORT PLATFORM

(71) Applicant: NCR Voyix Corporation, Atlanta, GA (US)

(72) Inventors: Marko Kalajdzic, Valencia (ES); Isidro Alfonso Vera Rodriguez, Atlanta, GA (US)

(21) Appl. No.: 19/092,757

(22) Filed: Mar. 27, 2025

(51) Int. Cl. H04L 41/5074; H04L 41/0681; H04L 41/069

(52) U.S. Cl. CPC H04L 41/5074; H04L 41/0681; H04L 41/069

(57) ABSTRACT

A dynamic support platform for information technology (IT) event management integrates data streaming, rule-based event detection, remote action workflows, and knowledge management for automated issue resolution across distributed computing resources. The platform includes a data ingestion service that collects and normalizes data from endpoints, a rule engine that evaluates data against user-defined rules, a workflow orchestrator that selects corresponding workflows from a library, and a remote action service that executes commands on endpoints. A no-code/low-code interface enables technical users to configure event triggers and automated responses without relying on developers. The platform provides a unified user interface consolidating visibility across multiple organizations, sites, and devices, with automatic logging of incident details and remediation steps into a knowledge repository. The same agent and orchestration framework can be used to deliver software updates and packages to endpoints, with integration to trigger updates as part of resolution workflows.

### BACKGROUND

Existing tools in the information technology (IT) operations domain are often siloed, focusing on specific functionalities such as data monitoring, basic alerts, or partial remote remediation. Conventional solutions frequently rely on complex scripting and specialized knowledge, limiting ease of configuration by non-developers. Furthermore, conventional IT troubleshooting processes rely heavily on manual steps and fragmented documentation. This leads to inefficient resolution of repeated incidents and lack of organized knowledge transfer across teams. IT teams must juggle multiple tools without a single pane of glass to oversee the entire IT infrastructure, resulting in increased downtime, operational inefficiencies, and high technical complexity in event handling and automation. Organizations must rely on specialized software engineers to set up and maintain rule-based event handling and automation logic, while incident details, troubleshooting steps, and resolution workflows are often poorly documented or scattered across multiple sources.

### BRIEF DESCRIPTION OF THE DRAWINGS

FIG. 1 is a diagram of a system for a dynamic support platform (DSP), according to an example embodiment.

FIG. 2 is a flow diagram of a method for onboarding a new customer to the DSP, according to an example embodiment.

FIG. 3 is a diagram depicting stages associated with processing events within the DSP, according to an example embodiment.

FIG. 4 is a flow diagram of methods for creating a software deployment, updating a software deployment, deploying a package associated with the software deployment, canceling a software deployment, and deleting a software deployment within the DSP according to an example embodiment.

FIG. 5 is an example a no-code/low-code user interface associated with the DSP, according to an example embodiment.

FIG. 6 is a flow diagram of a method for operating the DSP, according to an example embodiment.

FIG. 7 is a flow diagram of another method for operating the DSP, according to an example embodiment.

### DETAILED DESCRIPTION

In today's complex information technology (IT) environments, technical support teams face significant challenges when managing distributed computing resources. Traditional IT support platforms operate in isolation, creating disconnected silos of functionality that force technical consultants and site reliability engineers to navigate between multiple tools for monitoring, alerting, remediation, and knowledge management. These fragmented systems require specialized expertise to configure and maintain, often demanding custom scripting and development skills that exceed the capabilities of many IT professionals. When incidents occur, support personnel must manually correlate data from disparate sources, determine appropriate remediation steps, and document their actions across multiple platforms, which is a time-consuming process that extends resolution times and increases system downtime.

Furthermore, conventional support platforms lack effective mechanisms for knowledge retention and transfer. Troubleshooting steps, resolution workflows, and system insights remain scattered across various documentation repositories or exist only as tribal knowledge within specific teams. This fragmentation prevents organizations from building upon past experiences, forcing technical staff to repeatedly solve similar problems without the benefit of historical context or previously successful remediation strategies. The absence of integrated software distribution capabilities further complicates maintenance operations, as teams must coordinate updates and patches through separate systems disconnected from their monitoring and event management tools.

The technical challenge in IT operations stems from the disconnected nature of monitoring, event detection, remediation, and knowledge management systems. Current platforms require manual correlation of events across multiple tools, complex scripting for automation, and separate processes for executing remote actions and software updates. This technical fragmentation creates bottlenecks in incident response, extends mean time to resolution, and prevents the systematic capture of troubleshooting knowledge that could improve future operations. Additionally, the high technical barrier for configuring event rules and automated workflows restricts these capabilities to specialized developers, limiting broader adoption of automation across IT teams.

The technology disclosed herein provides a technical solution to at least the aforementioned technical problems through a unified microservices architecture that integrates data streaming, event processing, remote action execution, and knowledge management within a single platform. As discussed further below, a data ingestion service collects and normalizes information from distributed endpoints, while a configurable rule engine evaluates this data against user-defined thresholds and patterns. When triggers are detected, a workflow orchestrator automatically initiates appropriate remediation actions through a remote action service, which can execute commands and scripts on target devices. In an embodiment, all incident details and resolution steps are captured in a knowledge repository, creating a continuous feedback loop that improves future response capabilities. This integrated approach eliminates the technical barriers between monitoring and action, enabling faster resolution of incidents through automated workflows while systematically preserving operational knowledge.

The dynamic IT support platform described herein transforms maintenance and support operations through its comprehensive integration of previously disconnected functions. By consolidating real-time data ingestion, threshold monitoring, event-based rule execution, remote remediation, and knowledge capture under a single interface, technical teams gain unprecedented visibility and control over their distributed IT environments. As discussed further herein, a no-code/low-code interface enables technical consultants, site reliability engineers, and product owners to configure complex event rules and automated responses without specialized development expertise, democratizing automation capabilities across the organization. This empowers a broader range of technical staff to contribute to operational improvements, reducing dependency on core developers for routine configuration tasks.

In an embodiment, the platform's workflow orchestration capabilities transform how technical teams respond to incidents. When thresholds are breached or error patterns detected, the system can automatically execute predefined workflows that perform diagnostics, restart services, clear memory caches, or deploy hotfixes without human intervention. For more complex scenarios, the technology presented herein supports on-demand execution of remote commands and scripts, allowing technical consultants to quickly investigate and resolve issues from a centralized interface. The integrated software distribution module further streamlines maintenance by leveraging a same agent and orchestration framework to deliver updates and patches to endpoints, with support for both scheduled deployments and event-triggered updates. As described below, this unified approach to event management and software distribution creates a self-healing environment where many common issues can be automatically detected and resolved before they impact end users, significantly reducing system downtime and support costs.

As used herein and below, a “computer resource,” “resource,” and/or “computing resource” refers to various IT assets that generate data streams and can be monitored and managed by the DSP presented. Computer resources may include physical hardware virtual machines (VMs); software applications; a local collection of resources for network sites, applications, organizations, and devices associated therewith; network components; and cloud-based services from a customer, enterprise, and/or third-party managed IT infrastructure.

“An endpoint” represents various entities within a customer or enterprise IT environment that can be monitored and managed by the DSP. Endpoints may include device endpoints such as physical or virtual hardware components that execute software and generate operational data; logical groupings of devices based on physical or network location to form site endpoints, higher-level groupings that represent business units or departments to form organizational endpoints; and/or data sources that provided information to the DSP to form source endpoints. Thus, endpoints are not strictly hardware but represent various levels of abstraction with a customer or enterprise IT infrastructure that can be monitored, receive software updates, and have remote actions executed on them.

“Features” refer to specific capabilities or functionalities that can be assigned to customers within the DSP. Features are grouped into bundles and can include workflows, triggers, and articles that provide specific monitoring, remediation, or automation capabilities. Features can be requested, updated, and released as part of the DSP onboarding and configuration process. A “bundle” is a group of related workflows and features that can be assigned to a target customer or enterprise environment. Bundles allow for efficient management and deployment.

A “trigger” is a condition or a set of conditions defined as rules that, when met, initiates a workflow. Triggers are defined by query parameters, event descriptions, and event status indicators. A “workflow” is a sequence of automated actions that are executed in response to a trigger. Workflows can include diagnostic commands, remediation scripts, support and maintenance ticket creation, and other automated responses to detected events.

A “no-code/low-code interface is a graphical user interface that enables technical users such as technical consultants, site reliability engineers, and product owners to configure complex event rules and automated responses without specialized programming expertise. T his interface uses visual elements, drag-and-drop functionality, and pre-built components that allow users to define conditions through an intuitive interface, specifying metrics (e.g., processor load, memory usage), error strings, or custom logic without writing custom scripts.

A “knowledge repository” is a centralized storage system that captures and organizes incident details, root cause analyses, resolution steps, and outcomes to facilitate future problem management and continuous improvement. The repository enables the system to learn from past events and provide recommendations for similar issues.

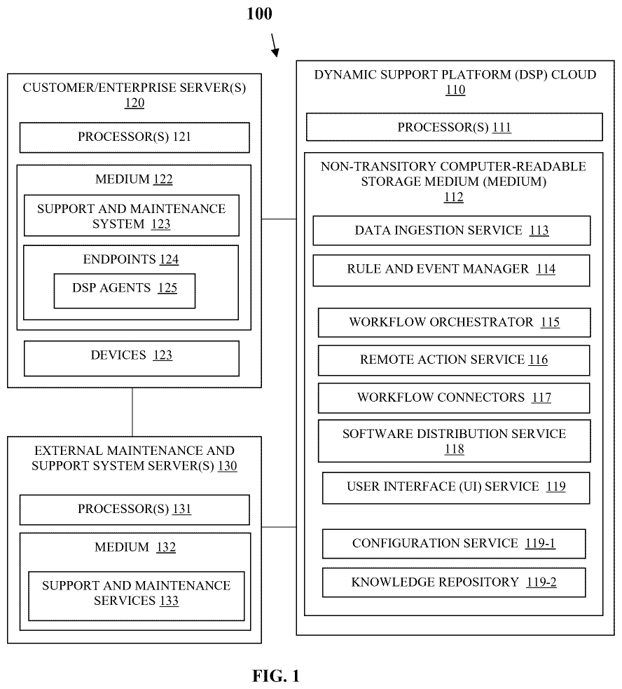

FIG. 1 is a diagram of a system 100 for a DSP, according to an example embodiment. Notably, the components are shown schematically in simplified form, with only those components relevant to understanding of the embodiments being illustrated.

Furthermore, the various components (that are identified in system 100) are illustrated and the arrangement of the components are presented for purposes of illustration only. Notably, other arrangements with more or less components are possible without departing from the teachings of a DSP, presented herein and below.

System 100 includes a cloud 110, one or more customer/enterprise servers 120, and one or more external maintenance and support system servers 130. Cloud 110 includes at least one processor 111 and a non-transitory computer-readable storage medium (hereinafter “medium”) 112, which includes instructions for a data ingestion service 113, a rule and event manager 114, a workflow orchestrator 115, a remote action service 116, workflow connectors 117, a software distribution service 118, a user interface (UI) service 119, and a configuration service 119-1. The instructions when executed by processor 111 cause processor 111 to perform processing or operations discussed herein and below with respect to 113-119-2. Medium 112 also includes a knowledge repository 119-2.

Each customer/enterprise server 120 includes at least one processor 121 and medium 122, which includes instructions for a support and maintenance system 123 and endpoints 124. Each endpoint 124 further includes instructions for a DSP agent 125. The instructions when executed by processor 121 cause processor 121 to perform processing or operations discussed herein and below with respect to 123-125. Each customer/enterprise server 120 further includes devices 126.

Each external maintenance and support system server 130 includes at least one processor 131 and medium 132, which includes instructions for support and maintenance services 133. The instructions when executed by the processor 131 cause the processor to perform procession or operations discussed herein and below with respect to 133.

The data ingestion service 113 collects logs, metrics, and telemetry data from endpoints using an agent or secure data feed and normalizes incoming data for consistent rule evaluation. The rule and event manager 114 continuously evaluates the normalized data against user-defined rules and thresholds, triggering alerts or workflows when conditions (e.g., CPU usage above 90%, device offline, error code 503) are met.

The workflow orchestrator 115 interprets triggers from the rule and event manager 114 and selects corresponding workflows from a workflow library. These workflows can invoke remote commands, scripts, or integration tasks such as creating or updating tickets in support and maintenance system 123 or external maintenance and support system server 130 via corresponding support and maintenance services 133. In an embodiment, the support and maintenance services 133 are associated with external IT service management systems (ITMSs). The remote action service 116 executes commands or scripts on endpoints 124 through an agent-based or agentless secure connection, supporting both manual (user-initiated) and automated (rule-triggered) modes of execution.

The workflow connectors 117 provide out-of-the-box integration with common support and maintenance services 133 (e.g., ITSM platforms, such as ServiceNow®, Jira®, etc.) to automatically open or update tickets, maintaining a complete audit trail. They also allow seamless communication via collaboration tools (e.g., Slack®, Microsoft Teams®, email) to keep relevant stakeholders informed of events and resolutions. The software distribution service 118 leverages the same agent 125 or remote connectivity to deliver software packages, patches, or updates, with support for device-based or group-based rollouts, real-time status, and rollback options if needed.

The user interface (UI) service 119 offers a no-code/low-code interface for rule creation, alert configuration, and workflow design, presenting a unified view of alerts, device health, active workflows, and knowledge articles. The no-code/low-code interface enables technical users such as technical consultants (TCs), site reliability engineers (SREs), and product owners to configure complex event rules and automated responses without specialized programming expertise. This interface uses visual elements, drag-and-drop functionality, and pre-built components that allow users to define conditions through an intuitive interface, specifying metrics (e.g., central processing unit (CPU) load, memory usage), error strings, or custom logic without writing custom scripts.

The configuration service 119-1 provides tools for setting up and managing the DSP, including onboarding new customers and configuring data streams. The knowledge repository 119-2 stores incident details, root cause analysis, and resolution data as knowledge items, facilitating self-improvement by enabling future event triggers to leverage historical resolutions.

The support and maintenance system 123 may include internal ITSM tools or other support infrastructure used by the customer organization. The endpoints 124 represent various devices, sites, organizations, and sources that generate data and can be monitored and managed by the DSP. The DSP agents 125 are installed on the endpoints 124 to collect data and execute remote actions as directed by the DSP cloud 110. The devices 126 represent the physical hardware that hosts the endpoints and agents 125.

The external maintenance and support system server(s) 130 include one or more processors 131 and a medium 132 that stores and executes support and maintenance services 133. These external systems may include third-party ITSM platforms like ServiceNow® or Jira® that integrate with the DSP through the workflow connectors 117.

In operation, the DSP cloud 110 ingests data from the customer/enterprise server(s) 120 through the data ingestion service 113, processes this data using the rule and event manager 114, and when triggers are detected, initiates workflows through the workflow orchestrator 115. These workflows may involve executing remote actions on the endpoints 124 via the remote action service 116, creating tickets in external systems through the workflow connectors 117, or deploying software updates via the software distribution service 118. All of these operations are configured and monitored through the UI service 119, with incident details and resolution steps stored in the knowledge repository 119-2 for future reference.

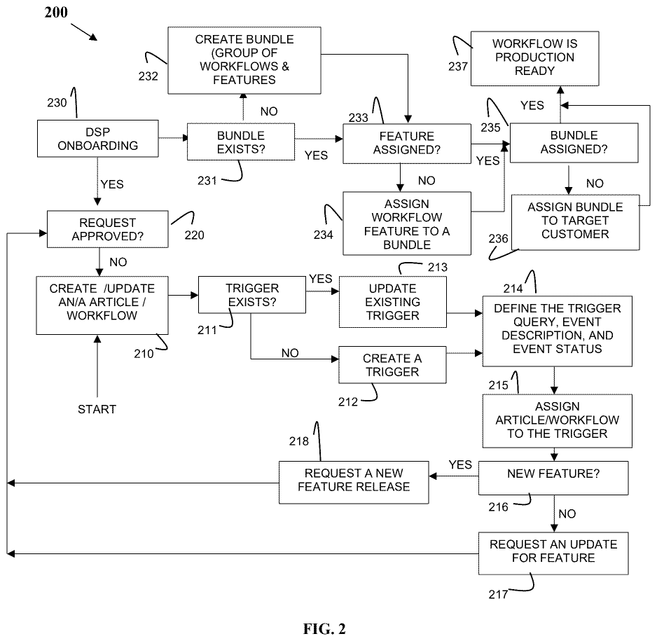

FIG. 2 is a flow diagram of a method 200 for onboarding a new customer to the DSP, according to an example embodiment. The flow diagram depicts both the customer onboarding process and the workflow/feature assignment process.

The method 200 begins at start block 210, which initiates the DSP onboarding process. At block 211, the system 100 determines whether a trigger exists for a particular workflow or feature. If a trigger does not exist (“NO” path from block 211), the method 200 proceeds to block 212 where a new trigger is created. Following the creation of a trigger, at block 214, the system 100 defines the trigger query, event description, and event status. These parameters specify the conditions under which the trigger will activate workflows.

If a trigger already exists (“YES” path from block 211), the method 200 moves to block 213 where the existing trigger is updated. After either creating a new trigger (block 212) or updating an existing one (block 213), the method 200 proceeds to block 218, where an article or workflow is assigned to the trigger. This assignment links specific remediation actions or knowledge content to the defined trigger conditions.

At block 216, the system 100 determines whether a new feature is being requested. If a new feature is required (“YES” path from block 216), the method 200 moves to block 217 where a request for a new feature release is initiated. If an existing feature needs modification (“NO” path from block 216), the method 200 proceeds to block 215 where a request for a feature update is submitted.

Following the feature request or update, at block 220, the system 100 evaluates whether the request is approved. If the request is not approved (“NO” path from block 220), the method 200 returns to the appropriate previous step for revision. If the request is approved (“YES” path from block 220), the method 200 advances to the workflow and bundle assignment phase.

At block 230, the system 100 determines whether the workflow is production ready. If the workflow is not production ready (“NO” path from block 230), the method 200 returns to earlier stages for further development. If the workflow is production ready (“YES” path from block 230), the method 200 proceeds to block 231 where the system 100 checks if a bundle exists for grouping related workflows and features.

If a bundle does not exist (“NO” path from block 231), the method 200 moves to block 232 where a new bundle (group of workflows and features) is created. Following bundle creation or if a bundle already exists (“YES” path from block 231), the method 200 proceeds to block 233 where the system 100 determines whether the feature has been assigned to a bundle.

If the feature has not been assigned (“NO” path from block 233), the method 200 moves to block 234 where the workflow feature is assigned to a bundle. Once the feature is assigned or if it was already assigned (“YES” path from block 233), the method 200 advances to block 235 where the system 100 checks if the bundle has been assigned to a target customer.

If the bundle has not been assigned (“NO” path from block 235), the method 200 moves to block 236 where the bundle is assigned to the target customer. Once the bundle is assigned or if it was already assigned (“YES” path from block 235), the method 200 concludes at block 237 with the DSP onboarding process completed. At this point, the customer has been successfully onboarded to the DSP with the appropriate workflows, features, and triggers configured for their IT infrastructure environment.

The onboarding method 200 illustrated in FIG. 2 enables a structured approach to configuring the DSP for new customers, ensuring that appropriate monitoring, event detection, and automated remediation capabilities are properly set up. The method 200 supports both the creation of new components (triggers, features, bundles) and the reuse of existing components, promoting efficiency and consistency across customer implementations.

The onboarding method 200 includes specific procedures for the initial setup and configuration of DSP agents 125 on customer endpoints 124. Following bundle assignment at block 236, the system 100 initiates an agent deployment phase where the DSP agents 125 are distributed to the target endpoints 124 identified during the onboarding process. The agent deployment utilizes the software distribution service 118 to securely deliver the agent installation packages to each endpoint type (e.g., device, site, organization, and source endpoints). During installation, each agent 125 is configured with unique identifiers that associate it with the customer's organizational hierarchy and security context. The agent 125 establishes initial communication with the DSP cloud 110 through a secure handshake protocol that verifies the agent's identity and authorizes its connection to the data ingestion service 113. As part of this initialization, the agent 125 receives its monitoring configuration, including which metrics to collect, collection frequency, and data transmission parameters. The agent 125 also receives initial rule sets that define local preprocessing of data before transmission, reducing network overhead by filtering non-essential information. This agent configuration is derived from the feature bundles assigned during the onboarding process, ensuring that each agent 125 is optimized for the specific monitoring and remediation capabilities required by the customer.

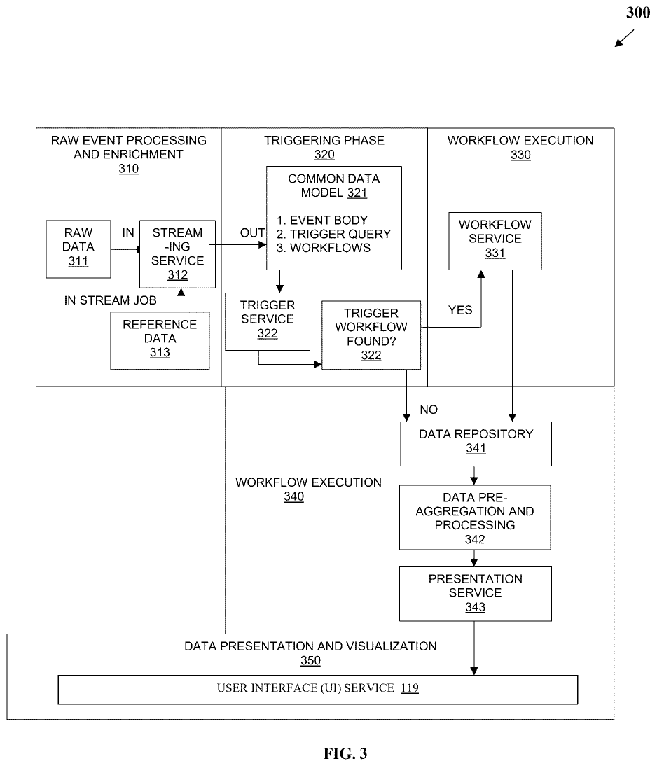

The triggers created or updated in blocks 212-214 of FIG. 2 define the conditions evaluated by the trigger service 322 shown in FIG. 3 below. Similarly, the workflows assigned to triggers in block 218 of FIG. 2 are the same workflows executed by the workflow service 331 in FIG. 3 when corresponding triggers are detected.

FIG. 3 is a diagram depicting stages associated with processing events within the DSP 300, according to an example embodiment. The diagram shows the complete event processing pipeline from raw data ingestion through workflow execution to data presentation and visualization.

The event processing begins with the raw event processing and enrichment stage 310. In this initial stage, raw data 311 is ingested from various sources through a streaming service 312. The raw data 311 includes logs, metrics, and telemetry data from monitored endpoints 124. This data is enriched with reference data 313 to provide context and enable more effective analysis. The enrichment process normalizes the incoming data into a consistent format that can be evaluated by the rule engine.

Following the initial processing, the data flows to the triggering phase 320. In this phase, the enriched data is transformed into a common data model 321, which provides a standardized structure for consistent rule evaluation. The trigger service 322 evaluates the data against predefined rules and conditions. At decision point 322, the system determines whether a trigger for a workflow condition is met. If a trigger is identified (the “YES” path), the process advances to the workflow execution stage 330. If no trigger is found (the “NO” path), the data continues to be stored for future reference and analysis.

The workflow execution stage 330 begins when a trigger is detected. The workflow service 331 receives three key inputs: (1) the event body containing the details of the detected condition, (2) the trigger query that was matched, and (3) the workflows that should be executed in response to the trigger. The workflow service 331 then orchestrates the execution of the selected workflows, which may include diagnostic commands, remediation scripts, or integration tasks with external systems (e.g., support and maintenance services 133 of external maintenance and support system servers 133 and/or support and maintenance system 123 of customer/enterprise environment).

Concurrently, the system 100 maintains a data repository 341 as part of the workflow execution stage 340. This repository stores all event data, trigger conditions, and workflow execution details. The data pre-aggregation and processing component 342 performs analysis on this stored data to identify patterns, trends, and insights that can improve future event detection and response via knowledge repository 119-2. The presentation service 343 prepares the processed data for visualization and reporting.

The final stage is data presentation and visualization 350, which is delivered through the UI Service 119. This service provides a unified view of the entire event processing pipeline, allowing users to monitor real-time events, track workflow execution status, and analyze historical data. The UI Service 119 presents this information through dashboards, reports, and interactive visualizations that enable technical teams to quickly identify and respond to issues.

The event processing flow illustrated in FIG. 3 demonstrates how the DSP transforms raw operational data into actionable insights and automated responses. By integrating data collection, event detection, workflow execution, and visualization into a seamless pipeline, the system 100 enables faster incident resolution and continuous improvement of IT operations. The structured approach to event processing ensures that appropriate actions are taken in response to detected conditions, while the comprehensive data storage and analysis capabilities support ongoing optimization of rules and workflows.

The raw event processing and enrichment stage 310 is implemented by the data ingestion service 113 shown in FIG. 1. Similarly, the triggering phase 320 is executed by the rule and event manager 114, while the workflow execution stage 330 is handled by the workflow orchestrator 115 and remote action service 116.

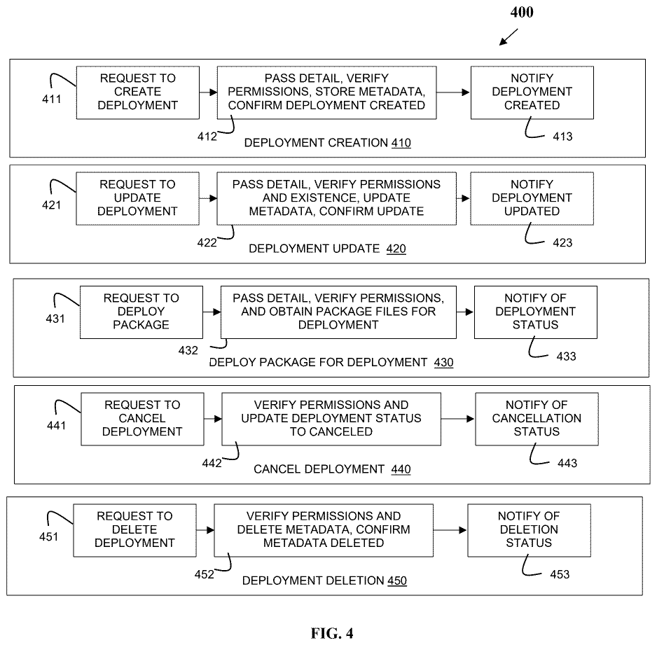

When the workflow service 331 in FIG. 3 determines that a software update is required as part of a remediation workflow, it can initiate a deployment creation method 410 as shown in FIG. 4 below. This integration enables automated software updates in response to specific triggers, creating a self-healing capability within the system 100.

FIG. 4 is flow diagrams of methods (410, 420, 430, 440, and 450) for creating a software deployment, updating a software deployment, deploying a package associated with the software deployment, canceling a software deployment, and deleting a software deployment within the DSP according to an example embodiment. The diagram depicts five distinct deployment operations: deployment creation, deployment update, deploy package for deployment, cancel deployment, and deployment deletion.

The deployment creation method 410 begins when a request to create a deployment is received at block 411. This request typically originates from a distributor or release manager who has selected one or more packages or package groups and target device groups for deployment. At block 412, the method 410 passes deployment details, verifies permissions, stores metadata, and confirms that the deployment has been created. During this process, the system 100 performs comprehensive validation of the deployment configuration, including verification of package compatibility with target endpoints, checking for required system resources (disk space, memory, processor requirements), and validating that prerequisite software components are present. The system 100 also analyzes dependencies between packages, constructing a dependency graph to determine the correct installation sequence and identifying any circular dependencies that might cause installation failures. For deployments targeting multiple time zones, the system 100 implements intelligent scheduling that converts deployment windows to local time for each endpoint, preventing business disruptions by respecting defined maintenance windows while optimizing parallel deployments where possible. The system 100 also evaluates network bandwidth requirements and can automatically throttle deployment rates to prevent network congestion. This validation ensures that only properly configured deployments proceed to execution, reducing the risk of failed installations. Once the deployment is successfully created, at block 413, the method 410 notifies relevant stakeholders that the deployment has been created and is ready for the next steps.

The deployment update method 420 begins when a request to update a deployment is received at block 421. This may occur when deployment parameters need to be modified before execution. At block 422, the method 420 passes the updated details, verifies permissions and the existence of the deployment, updates the metadata, and confirms that the update has been completed. During this process, the method 420 implements version control by creating a new version of the deployment configuration while preserving previous versions in an immutable history log. Each update is tracked with a unique version identifier, timestamp, and the identity of the user making the change. The system 100 maintains a complete audit trail of all modifications, including changes to target endpoints 124, package versions, deployment schedules, and execution parameters. This comprehensive change tracking enables rollback to previous deployment configurations if needed and provides accountabilities for all modifications. The verification ensures that only authorized users can modify deployments and that the deployment being updated actually exists in the system 100. Following the successful update, at block 423, the method 420 notifies relevant stakeholders of the deployment update status, including details about what specific parameters were changed from the previous version.

The deploy package for deployment method 430 begins when a request to deploy a package is received at block 431. This request initiates the actual software distribution process to target endpoints. At block 432, the method 430 passes deployment details, verifies permissions, and obtains the package files required for deployment. During this step, the DSP agent 125 on each endpoint 124 receives deployment instructions from the system 100, downloads the package securely through an encrypted connection, and executes an installation script. The installation process follows a structured sequence where the agent 125 first validates the package integrity using checksum verification before proceeding with installation. The installation script runs the uploaded installation file, configures necessary application settings, and writes installation status and timestamp into the system registry for verification. Specifically, the agent creates registry entries that indicate success (status key=0) or failure (status key=1) along with a date key that records the precise date and time of installation. After installation completion, the agent 125 performs validation by reading these registry entries to verify successful installation and reports results back to the DSP. This closed-loop verification ensures that deployments are properly tracked and validated. After deployment execution, at block 433, the method 430 notifies relevant stakeholders of the deployment status, including success or failure information for each target endpoint, enabling real-time tracking and troubleshooting of deployment issues.

The security measures implemented during package deployment ensure data integrity and protect against unauthorized access or tampering. When establishing communication, the DSP agent 125 and the central system 100 authenticate each other using mutual TLS (Transport Layer Security) certificates with a minimum of 2048-bit key length, preventing man-in-the-middle attacks. All package data is transmitted through encrypted channels using industry-standard protocols such as TLS 1.3 or higher, with the package contents themselves being encrypted using AES-256 encryption both at rest and in transit. Before installation begins, the DSP agent 125 verifies the digital signature of the package using SHA-256 hashing algorithms to confirm it originated from an authorized source and hasn't been modified. The agent 125 also enforces least-privilege execution, running installation scripts with only the permissions necessary to complete the deployment. Additionally, the system 100 maintains comprehensive audit logs of all deployment activities, recording who initiated the deployment, when it occurred, and the specific actions performed on each endpoint 124. These security measures work in conjunction with the permission verification mentioned in block 432 to create a defense-in-depth approach that protects the integrity of the software distribution process.

The DSP implements comprehensive error handling and recovery procedures to ensure deployment reliability even when issues occur. When a package installation fails, the DSP agent 125 captures detailed error logs including exit codes, error messages, and system state information, then transmits this diagnostic data to the central system 100 for analysis. For network interruptions during download, the agent 125 implements a checkpoint-based resumable transfer protocol using the Background Intelligent Transfer Service (BITS) or similar technology that allows downloads to continue from the point of interruption rather than restarting, conserving bandwidth and reducing deployment time. The agent 125 utilizes delta compression algorithms to transfer only changed portions of files when updates are deployed, further optimizing network usage. If an installation fails mid-process, the agent 125 executes a predefined rollback procedure that restores the endpoint 124 to its pre-installation state by removing partially installed components, restoring backed-up files, and reverting registry changes. For critical systems, the agent 125 can create a system restore point before installation begins, enabling complete system state recovery if needed. The DSP also implements deployment policies including retry logic with configurable attempts and exponential backoff intervals (starting at 30 seconds and doubling with each attempt) for transient failures, and circuit breaker patterns that prevent repeated failed attempts when systemic issues are detected. These recovery mechanisms ensure that endpoints 124 remain in a consistent, operational state even when deployment challenges occur.

The cancel deployment method 440 begins when a request to cancel a deployment is received at block 441. This may occur when a deployment needs to be halted before completion. At block 442, the method 440 verifies permissions and updates the deployment status to canceled. This ensures that only authorized users can cancel deployments and prevents further execution of the deployment process. Following the cancellation, at block 443, the method 440 notifies relevant stakeholders of the cancellation status.

The deployment deletion method 450 begins when a request to delete a deployment is received at block 451. This typically occurs when a deployment is no longer needed and should be removed from the system 100. At block 452, the method 450 verifies permissions and deletes the deployment metadata, confirming that the metadata has been successfully removed. This verification ensures that only authorized users can delete deployments and that all associated records are properly removed from the system 100. Following the deletion, at block 453, the method 450 notifies relevant stakeholders of the deletion status.

The software deployment operations illustrated in FIG. 4 demonstrate how the DSP manages the complete lifecycle of software deployments, from creation through execution to cancellation or deletion. These operations integrate with the broader event management capabilities of the DSP, allowing software updates to be triggered automatically in response to detected events or conditions. The structured approach to deployment management ensures proper authorization, tracking, and notification throughout the deployment process, while the integration with DSP agents enables secure and reliable software distribution to endpoints.

The software distribution service 118 as shown in FIG. 1 implements the deployment operations illustrated in FIG. 4, including deployment creation 410, deployment update 420, package deployment 430, deployment cancellation 440, and deployment deletion 450. These operations utilize the DSP agents 125 installed on endpoints 124 to securely deliver and install software packages.

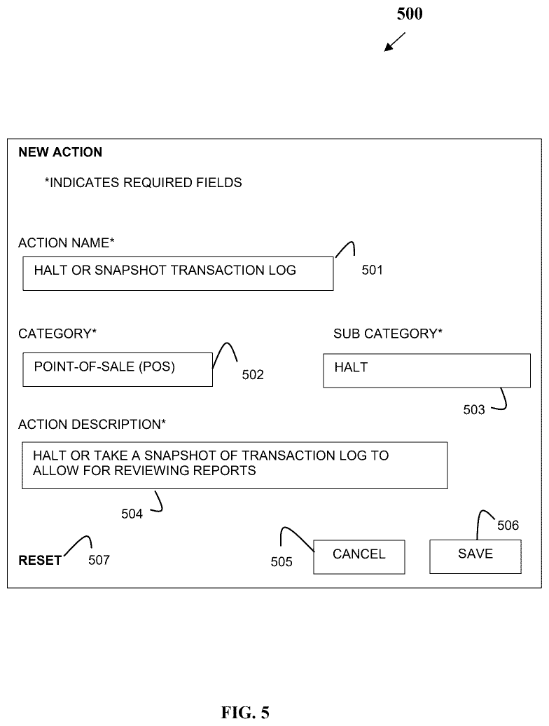

FIG. 5 illustrates a sample screenshot 500 of a no-code/low-code user interface associated with the DSP, according to an example embodiment. This interface is provided by the UI service 119 described in FIG. 1 and enables technical users to configure rules and actions without specialized programming expertise. The screenshot shows a “New Action” creation interface with several required fields marked with asterisks (*). The interface includes an action name field 501 where users can enter a descriptive name for the action (shown as “HALT OR SNAPSHOT TRANSACTION LOG”). The category field 502 allows users to select a category for the action (shown as “POINT-OF-SALE (POS)”), while the sub-category field 503 enables further classification (shown as “HALT”). An action description field 504 provides space for detailed explanation of what the action does (shown as “HALT OR TAKE A SNAPSHOT OF TRANSACTION LOG TO ALLOW FOR REVIEWING REPORTS”). The interface includes control buttons for cancel 505, save 506, and reset 507 operations. T his visual, form-based approach to action configuration demonstrates how the DSP enables technical consultants, site reliability engineers, and product owners to create complex automated responses without writing custom scripts and without the need for any code developers, as discussed above.

The no-code/low-code interface implements a sophisticated translation layer that converts visual configurations into executable rules and workflows through a multi-stage technical process. When a user configures an action through the interface shown in FIG. 5, the system 100 internally generates a structured JSON representation of the configuration, capturing all parameters, conditions, and relationships defined in the visual elements. This JSON structure is then processed by a rule compiler service that transforms the abstract representation into concrete execution instructions. The compiler applies syntax validation, semantic analysis, and optimization techniques to ensure the generated rules are efficient and error-free. For complex conditional logic, the system 100 employs a decision tree algorithm that converts visual condition builders into optimized boolean expressions. These expressions are stored in a rule repository as executable templates that can be instantiated at runtime. When triggers activate these rules, a workflow interpreter dynamically binds variables from the event context to the rule parameters and executes the defined actions through the remote action service 116. This technical approach creates a separation between the visual representation and execution logic, allowing non-technical users to create sophisticated automation while maintaining the performance and reliability requirements of enterprise IT operations. The system 100 also maintains versioning of these rule translations, enabling rollback capabilities and audit trails of rule modifications over time.

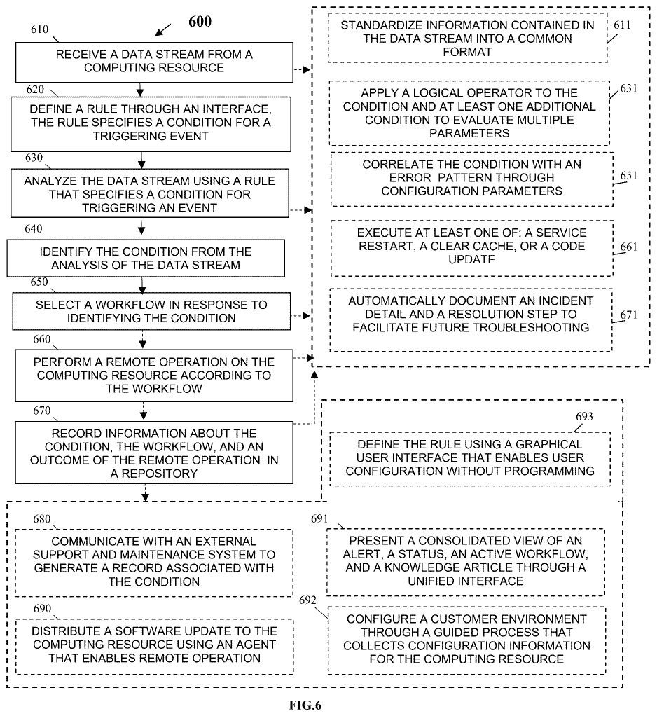

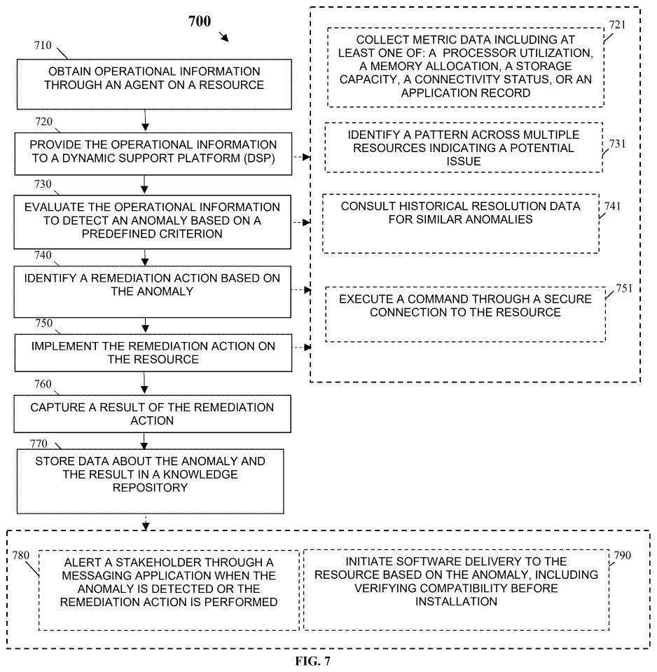

Before discussing the specific operational methods shown in FIGS. 6 and 7, it's important to understand how the DSP's technical architecture enables the practical implementation of its event management and remediation capabilities. The DSP's microservices-based design allows for horizontal scaling to handle large enterprise environments while maintaining modularity that enables organizations to activate only the features they need. This architecture supports multi-tenancy, allowing multiple companies or departments to manage their own IT environments within the same system. The platform's cloud-native, containerized implementation ensures flexibility, high availability, and rapid deployment across on-premises, hybrid, or cloud-based infrastructures. This technical foundation enables the DSP to process high volumes of operational data in real-time, apply complex rule evaluations, and execute automated remediation workflows with minimal latency. The platform's ability to integrate event detection, rule-based automation, remote action orchestration, and knowledge management into a unified system addresses the fundamental technical challenges outlined earlier by eliminating the disconnected nature of traditional IT operations tools. This integration creates a technical environment where monitoring seamlessly transitions to action, reducing mean time to resolution and enabling the systematic capture of troubleshooting knowledge that improves future operations.

FIG. 6 is a flow diagram of a method 600 for operating the DSP, according to an example embodiment. The software module(s) that implements the method 600 is referred to as an “automated maintenance and support service.” The automated maintenance and support service is implemented as executable instructions programmed and residing within memory and/or a non-transitory computer-readable (processor-readable) storage medium and executed by one or more processors of one or more device(s). The processors that execute the automated maintenance and support service are specifically configured and programmed for processing the automated maintenance and support service. The automated maintenance and support service may have access to one or more network connections during its processing. The network connections can be wired, wireless, or a combination of wired and wireless.

In an embodiment, the device that executes the automated maintenance and support service is cloud 110. In an embodiment, a combination of devices execute the automated maintenance and support service including cloud 110 and customer/enterprise server 120. In an embodiment, the automated maintenance and support service is 113-119-2 and/or 125.

At 610, automated maintenance and support service receives at least one data stream of events from a computing resource of a customer/enterprise server 120. In an embodiment, at 611, the automated maintenance and support service standardizes and enriches information contained in the data stream into a common format for consistent analysis.

At 620, the automated maintenance and support service defines a rule through an interface. The rule specifies a condition for a triggering event.

At 630, the automated maintenance and support service analyzes the data stream using the rule that specifies a condition for triggering an event. In an embodiment, at 631, the automated maintenance and support service applies a logical operator to the condition and at least one other condition evaluate multiple parameters.

In an embodiment, at 640, the automated maintenance and support service identifies the condition from the analysis of the data stream. At 650, the automated maintenance and support service selects a workflow from a workflow library in response to identifying the condition. In an embodiment, at 651, the automated maintenance and support service correlates the condition with an error pattern through configuration parameters.

At 660, the automated maintenance and support service performs a remote operation on the computing resource according to the workflow. In an embodiment, at 661, the automated maintenance and support service executes at least one of: a service restart, a clear cache, or a code update as the remote operation.

At 670, the automated maintenance and support service records information about the condition, the workflow, and an outcome in a repository. In an embodiment, at 671, the automated maintenance and support service automatically documents an incident detail and a resolution step to facilitate future troubleshooting.

In an embodiment, at 680, the automated maintenance and support service communicates with an external support and maintenance system (123 and/or 133) to generate a record associated with the condition. In an embodiment, at 690, the automated maintenance and support service distributes a software update to the computing resource using an agent 125 that enables remote operation.

In an embodiment, at 691, the automated maintenance and support service presents a consolidated view of an alert, a status, an active workflow, and a knowledge article through a unified interface using UI service 119. In an embodiment, at 692, the automated maintenance and support service configures a customer or enterprise environment through a guided process that collects configuration information for the computing resource. In an embodiment, at 693, the automated maintenance and support service defines a rule using a graphical user interface that enables user configuration without programming or a code developer being required.

FIG. 7 is a flow diagram of another method 700 for operating the DSP, according to an example embodiment. The software module(s) that implements the method 700 is referred to as a “DSP service.” The DSP service is implemented as executable instructions programmed and residing within memory and/or a non-transitory computer-readable (processor-readable) storage medium and executed by one or more processors of one or more device(s). The processors that execute the DSP service are specifically configured and programmed for processing the DSP service. In an embodiment, the DSP service may have access to one or more network connections during its processing. The network connections can be wired, wireless, or a combination of wired and wireless.

In an embodiment, the device(s) that execute(s) the DSP service is cloud 310, cloud 110, and/or customer/enterprise 120. In an embodiment, the DSP service is 113-119-2, 125, and/or method 600. The DSP service presents another processing perspective from that which was discussed above with method 600 of FIG. 6.

At 710, the DSP service obtains operational information through an agent 125 on a resource. Again, the resource may include a device, an application, a sites with associated with a logical collection of resources, and an organizations associated with a logical collection of resources. At 720, the DSP service provides the operational information to the DSP of cloud 110. In an embodiment, at 721, the DSP service collects metric data including at least one of: a processor utilization, a memory allocation, a storage capacity, or an application record.

At 730, the DSP service evaluates the operational information to detect an anomaly based on a predefined criterion. In an embodiment, at 731, the DSP service identifies a pattern across multiple resources indicating a potential issue.

At 740, the DSP service identifies a remediation action based on the anomaly. In an embodiment, at 741, the DSP service consults historical resolution data for similar anomalies to the anomaly.

At 750, the DSP service implements the remediation action on the resource. In an embodiment, at 751, the DSP service executes a command through a secure connection to the resource.

At 760, the DSP service captures a result of the remediation action once implemented on the resource. At 770, the DSP service stores data about the anomaly in a knowledge repository 119-2.

In an embodiment, at 780, the DSP service alerts a stakeholder through a messaging application when the anomaly is detected or the remediation action is performed. In an embodiment, at 790, the DSP service initiates software delivery to the resource based on the anomaly including verifying compatibility before installation on the device 126.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method comprising:
receiving a data stream from a computing resource;
defining a rule through an interface, wherein the rule specifies a condition for triggering an event;
analyzing the data stream using a particular rule that specifies a particular condition for triggering a particular event;
identifying the particular condition from analysis of the data stream;
selecting a workflow in response to identifying the particular condition;
performing a remote operation on the computing resource according to the workflow; and
recording information about the particular condition, the workflow, and an outcome of the remote operation in a repository.

2. The method of claim 1, wherein receiving the data stream comprises standardizing information into a common format for consistent analysis.

3. The method of claim 1, further comprising defining the rule using a graphical interface that enables user configuration without programming.

4. The method of claim 1, wherein analyzing the data stream comprises applying a logical operator to the particular condition and at least one additional condition in order to evaluate multiple parameters associated with the particular rule.

5. The method of claim 1, wherein selecting the workflow comprises correlating the condition with an error pattern through configurable parameters.

6. The method of claim 1, wherein performing the remote operation comprises executing at least one of: a service restart, a clear cache, or a code update.

7. The method of claim 1, wherein recording information comprises automatically documenting an incident detail and a resolution step to facilitate future troubleshooting.

8. The method of claim 1, further comprising communicating with an external support and maintenance system to generate a record associated with the particular condition.

9. The method of claim 1, further comprising distributing a software update to the computing resource using an agent that enables the remote operation.

10. The method of claim 1, further comprising presenting a consolidated view of an alert, a status, an active workflow, and a knowledge article through a unified interface.

11. The method of claim 1, further comprising configuring a customer environment through a guided process that collects configuration information for the computing resource.

12. A method, the method comprising:
obtaining operational information through an agent associated with a resource;
providing the operational information to a dynamic support platform;
evaluating the operational information to detect an anomaly based on a predefined criterion;
identifying a remediation action based on the anomaly;
implementing the remediation action on the resource;
capturing a result of the remediation action; and
storing data about the anomaly and the result in a knowledge repository.

13. The method of claim 12, wherein providing operational information comprises collecting metric data including at least one of: a processor utilization, a memory allocation, a storage capacity, a connectivity status, or an application record.

14. The method of claim 12, wherein evaluating the operational information comprises identifying a pattern across multiple resources indicating a potential issue.

15. The method of claim 12, wherein identifying the remediation action comprises consulting historical resolution data for similar anomalies.

16. The method of claim 12, wherein implementing the remediation action comprises executing a command through a secure connection to the resource.

17. The method of claim 12, further comprising alerting a stakeholder through a messaging application when the anomaly is detected or the remediation action is performed.

18. The method of claim 12, further comprising initiating software delivery to the resource based on the anomaly, including verifying compatibility before installation.

19. A system, comprising:
a dynamic support platform configured to:
collect data from a device;
evaluate the data using a rule; and
manage a workflow to enable diagnosing or resolving an issue;
an interface to provide a visual environment to enable creation of a trigger, an event rule, and an automated workflow without coding;
an action coordinator configured to execute a command on the device in response to a manual request or an automated trigger;
a data store including historical event information and resolution procedure, accessible through the interface to provide recommendation in real time; and
a distribution component configured to deliver software to the device, wherein the distribution component operates in response to manual activation or automated detection through the rule.

20. The system of claim 19, wherein the distribution component verifies device compatibility before delivery, prevents incompatible installation, and supports targeted distribution with monitoring and reversal capability.
